(19) United States
(12) Patent Application Publication
(10) Pub. No.: US 2007/0223645 A1
(43) Pub. Date: Sep. 27, 2007

(54) Bonding Radioactive Iodine in a Nuclear Reactor

(76) Inventors: Wilfried Ruehle, Eppelheim (DE); Heribert Schmitt, Schifferstadt (DE); Werner Seider, Hambruecken (DE)

Correspondence Address: Walter A. Hackler;Patent Law Office, 2372 S.E. Bristo Street , Suite B, Newport Beach, CA, 92660, US

(21) Appl. No.: 11/587,425

(22) PCT Filed: May 4, 2005
(86) PCT No.: PCT/EP05/04844

§ 371 Date: Oct. 24, 2006

(30) Foreign Application Priority Data
May 19, 2004 (DE) 10 2004 024 722.6

(51) Int. Cl. G21C 19/307

(52) U.S. Cl. 376/310; 376/308

(57) ABSTRACT

The invention relates to a method for counteracting the escape of radioactive iodine from a cooling system of a water-cooled nuclear reactor, a reducing agent being introduced into the cooling system of the reactor during a shutdown of the reactor and/or during a subsequent after-cooling operation.

Radioactive iodine (I¹¹³¹) is formed constantly during the operation of nuclear reactors. Iodine is readily volatile and is deposited in the thyroid in man. Radioactive iodine therefore represents an appreciable source of danger for human health.

Nuclear reactors must be shut down at regular intervals for inspection and maintenance work and radioactivity-carrying systems, such as the cooling system and/or the reactor core, must be opened. Expensive exhaust measures are necessary in order to prevent the escape of radioactive iodine during these operations and may last several days. If the fuel rods are defective, there is increased formation of air-borne iodine compounds, which makes an appreciably greater radiation-protection effort necessary.

The time required for the inspection and maintenance work depends, to a considerable extent, on the exhaust measures activity-carrying systems are opened. The longer the interval between a shutdown and a renewed start up of the nuclear reactor, the greater are the costs that arise due to loss of production, since power cannot be produced during this interval. Shortening the shutdown times of a reactor is therefore of very considerable economic importance.

It is an object of the invention to indicate a way, in which the escape of radioactive iodine from a nuclear reactor over the air path can be counteracted and inspection and maintenance work can be carried out more quickly.

This objective is accomplished by a method, for which a reducing agent is introduced into a cooling system of the reactor during a shutdown of the latter and/or during a subsequent after-cooling operation.

The escape of radioactive iodine from a nuclear reactor can be counteracted by using a reducing agent.

Iodine molecules and iodine-containing molecules are readily volatile. On the other hand, iodide ions remain in aqueous solutions even at high temperatures and are not transferred to the atmosphere above these solutions. Even if the water is evaporated completely, iodide ions form non-volatile salts, which have high melting points, with cations, such as sodium ions, which are contained in the water. Iodide ions may be removed from the water phase with an ion exchanger.

According to the teachings of the present invention, iodine molecules and iodine-containing compounds can be reduced through the use of a reducing agent, so that iodide ions are formed. This procedure is suitable especially for iodine, which is dissolved in the cooling water of the nuclear reactor. In order to bond iodine, which is already in a gas phase, a reducing agent, preferably an organic compound in aqueous solution can be sprayed as a sort of mist. If the gas phase is at an elevated temperature, especially reducing agents, which bond iodine by an addition reaction, are also suitable. For this purpose, organic compounds with unsaturated bonds (that is, with aromatic rings or double and triple bonds between carbon atoms), such as butynediol, are particularly suitable.

It is an important finding of the present invention that, for achieving radiation protection while inspection and maintenance work is being carried out, it is not necessary to bond radioactive iodine permanently also under the operating conditions of the reactor. Instead, it suffices if the radioactive iodine is bonded for the duration of the maintenance work, during which the radioactivity-carrying systems are opened. For this reason, materials such as butynediol, which are decomposed rapidly during the operation of the reactor due to the effects of radiation or temperature, are also suitable for the present invention. It namely does not matter if, for example, iodine, bonded in the cooling cycle, is released once again at the conclusion of the maintenance work, since it then no longer can escape from the closed cooling system.

Within the scope of the present invention, the concept of “bonding” is not to be understood in its narrower chemical sense to imply that the radioactive iodine must enter into a chemical bond with the reducing agent. It suffices if the radioactive iodine is prevented in some way by the reducing agent from crossing over into the atmosphere. For example, the iodine can be bound as iodide ion in an aqueous solution or by an addition reaction, during which it enters into chemical bonding with the reducing agent and, together with the latter, is precipitated.

In the cooling system of a light water reactor, temperatures of several hundred degrees centigrade are attained during the operation of the reactor. Under these conditions, foreign matter can cause damage, especially due to corrosion. For this reason, it is necessary to take care that the cooling water used is as free of contamination as possible. Under the conditions of the reactor operation, organic molecules are rapidly decomposed in the cooling cycle and can therefore represent a source of corrosive foreign matter. In order to avoid damage, the inventive reducing agent should therefore be as free as possible of halogens and sulfur, since otherwise corrosive decomposition products could be formed from the reducing agent.

Surprisingly, despite its acidic action as a decomposition product of organic reducing agents, carbon dioxide is not critical in the cooling water cycle of a light water reactor, so that organic reducing agents can be added without problems to the coolant in concentrations of a few hundred milligrams per kilogram. This is more than sufficient for bonding radioactive iodine efficiently.

Experiments have shown that cooling systems of pressurized-water reactors are much less susceptible to damage by foreign matter than cooling systems of boiling-water reactors. Within the scope of the invention, it was found that even nitrogen-containing reducing agents, such as hydrazine, can be used in the cooling system of a pressurized-water reactor at least in concentrations of the order of tens of milligrams per kilogram of cooling water without damage resulting from nitrogen-containing decomposition products.

The DE 3100112 A1discloses the use of water-insoluble starch as a filter material, in order to remove elementary iodine from the water, which originates from a nuclear power plant and is to be cleaned.

Furthermore, it is known from DE 10123690 A1that an alcohol may be mixed with the primary coolant of a boiling water reactor in order to counter stress corrosion.

The invention is described in greater detail in the following by means of exemplary embodiments. The special features, described therein, can be used individually or in combination with one another, in order to create preferred embodiments of the invention.

If a light water reactor is switched off for maintenance work and a radioactivity-carrying system, such as a cooling system, must be opened, the danger exists that gas-borne, radioactive iodine emerges. In order to counteract an escape of radioactive iodine from the cooling system of a pressurized-water or boiling-water reactor pursuant to the invention, a reducing agent, which binds the radioactive iodine or reduces it to iodide, which is not volatile and has no tendency to go over into the gas phase, is added to the coolant when the reactor is being shut down.

The reducing agent contains one or more organic compounds as reducing component. In this connection, compounds are preferred, which contain one or more unsaturated carbon bonds, that is, double or triple bonds between carbon atoms, or an aromatic group. Compounds with a molecular weight of less than 300 a.u. in atomic mass units and especially less than 250 a.u. are particularly preferred as reducing component of the reducing agent. Preferably, the reducing agent is free of halogens and sulfur, that is, it contains sulfur or halogens only as impurities or in traces, preferably in a concentration of less than 100 ppm.

Preferably, the reducing agent contains, as reducing component, one or more compounds, which are built up exclusively from carbon, hydrogen and oxygen. Aside from hydrocarbons, especially aldehydes, preferably hydroquinone, resorcinol and/or pyrocatechol, alcohols and/or carboxylic acids, especially ascorbic acid, are suitable. The reducing agent is added to the coolant in a concentration of at least 0.1 μmoles/kg and preferably of at least 0.5 μmoles/kg. Concentrations of more than 1 mmole/kg are required, at most, in the case of very weak reducing agents for a largely complete bonding of the radioactive iodine. However, particularly in the case of carboxylic acids, such reducing agents are associated with an increasing danger of corrosive damage to the cooling system.

During the shut-down operation of a nuclear reactor and the thereupon following after-cooling operation, the reducing agent is metered in repeatedly, so that the concentration of the reducing agent in the coolant, based on its reducing component or components, does not fall below a specified limiting value of, preferably, about 0.1 μmoles/kg of coolant. In this way, the radioactive iodine, present in the cooling system, can be bonded rapidly and completely so that, when the cooling system subsequently is opened, the radioactive iodine cannot escape.

Since the temperature in the cooling system of the reactor falls constantly during the shut down of a nuclear reactor and the thereupon following after-cooling operation, it may be advantageous to use one reducing agent at the start at higher temperatures and a different one towards the end at lower temperatures. In this way, it is always possible to introduce a reducing agent, which is most suitable for bonding radioactive iodine under the particular conditions existing.

The metering in of reducing agent is continued not because the reducing agent is consumed by reaction with the radioactive iodine, but, primarily, because it is also decomposed relatively rapidly or removed by a cleaning filter in the after-cooling operation of the reactor.

In the case of a boiling water reactor, a first reducing agent or a first component of the reducing agent is used for the liquid-carrying parts of the cooling system and a second reducing agent or a second component of the reducing agent is used for the steam-carrying parts of the cooling system. A mixture of ascorbic acid and butynediol has proven to be particularly suitable for boiling water reactors. Ascorbic acid remains in the liquid-carrying part of the cooling system and bonds the radioactive iodine there by reducing it to iodine ions. Butynediol is entrained in the steam-carrying parts of the cooling system, where it is deposited on free surfaces, such as turbine blades, and bonds radioactive iodine from the gas phase there by an addition reaction. Butynediol, moreover, has the additional advantage that it protects metal surfaces in the steam-carrying parts of the cooling system against corrosion. Ascorbic acid and butynediol are added to the coolant in aqueous solution in each case in a concentration of at least 0.1 mg/kg and preferably in a concentration of 0.2 mg/kg of coolant. This corresponds to a concentration of 0.5 to 1 μmoles/kg of coolant for the ascorbic acid and a concentration of 0.25 to 0.5 μmoles/kg of coolant for the butynediol.

For a further exemplary embodiment, fine droplets of a reducing agent, such as ascorbic acid or quercetin, dissolved in water, are sprayed as a mist into the radioactivity-carrying systems, such as turbine condensers or steam lines. The concentration of the ascorbic acid or the quercetin in aqueous solution is 0.1 to 1 mg/kg of water. Even radioactive iodine, which has already reached the gas phase, can be bonded in this way.

During an exchange of fuel elements, the release of iodine can be counteracted by covering these fuel elements with water, which contains reducing agents.

Typically, a light water reactor must be shut down once a year for about 15 to 25 days for inspection and maintenance work. In a test of the method described, it was possible to operate the reactor once again already five days earlier. For this purpose, when shutting down the reactor, butynediol in an aqueous solution was introduced hourly into the cooling system at a concentration of 0.1 mg/kg of steam. Approximately 10 hours after the reactor was switched off, the temperature in the cooling system had fallen to such an extent, that the amount of steam was only about 10% of the original value. At this time, ascorbic acid in an aqueous solution was added to the (liquid) coolant at a concentration of 0.4 mg/kg of coolant. By following this procedure, it was possible to open the cooling system already about 24 hours after the reactor was shut down. On the other hand, according to the prior art, air frequently had to be pumped out of the cooling system for several days, in order to prevent the escape of radioactive iodine.

1. Method for counteracting an escape of radioactive iodine from a cooling system of a water-cooled nuclear reactor, said method comprising a step in which a reducing agent is introduced into the cooling system of the reactor during shutting down of the reactor and/or during a subsequent after-cooling operation.

2. Method according to claim 1, the reducing agent being free of halogens and sulfur.

3. Method according to any one of the preceding claims, the reducing agent containing one or more organic compounds as reducing component.

4. Method according to claim 3, characterized in that the compound has a molecular weight of less than 300 a.u. and preferably of less than 250 a.u.

5. Method according to claims 3 or 4, the reducing agent containing one or more compounds, which are built up exclusively from carbon, hydrogen and oxygen, as reducing component.

6. Method according to claim 5, the reducing agent containing one or more hydrocarbons as reducing component.

7. Method according to any one of the preceding claims, the reducing agent containing one or more compounds with an unsaturated carbon bond as reducing component.

8. Method according to one of the claims 2 to 7, the reducing component being an aldehyde, preferably hydroquinone, resorcinol and/or pyrocatechol, an alcohol and/or a carboxylic acid, preferably ascorbic acid.

9. Method according to any one of the preceding claims, the reducing agent being added to a coolant.

10. Method according to claim 9, the reducing agent being added to a liquid phase of the coolant.

11. Method according to claims 9 or 10, the reducing agent being added to the coolant in a concentration of at least 0.1 μmoles/kg and preferably of at least 0.5 μmoles/kg.

12. Method according to any one of the preceding claims, a first reducing agent or a first component of the reducing agent being used for the liquid-carrying parts of the cooling system and a second reducing agent or a second component of the reducing agent being used for the steam-carrying parts of the cooling system.

13. Method according to any one of the preceding claims, a reducing agent being added at least one further time during the after-cooling operation.

14. Method according to any one of the preceding claims, a lowering of the concentration of the reducing agent in the coolant below a specified value of, preferably, 0.1 μmoles/kg and especially of 0.5 μmoles/kg being counteracted by further additions of reducing agent.

15. Water-cooled nuclear reactor with a cooling system, in which there is a coolant, which contains an organic reducing agent in a concentration of at least 10 μmoles/kg and preferably of 100 μmoles/kg in an after-cooling operation of the nuclear reactor.
